(19) United States
(12) Patent Application Publication
(10) Pub. No.: US 2026/0267409 A1
(43) Pub. Date: Sep. 10, 2026

(54) MEASURING DEVICE AND FORCE FEEDBACK DEVICE

(71) Applicant: HONDA MOTOR CO., LTD., Tokyo (JP)

(72) Inventor: Hokuto AIZAWA, Saitama (JP)

(21) Appl. No.: 19/407,969

(22) Filed: Dec. 3, 2025

(30) Foreign Application Priority Data
Mar. 6, 2025 (JP) 2025-035221

(51) Int. Cl. G06F 3/01; B25J 13/08

(52) U.S. Cl. CPC G06F 3/014; B25J 13/085; B25J 13/088

(57) ABSTRACT

A device for measuring a position of a user's fingertip comprises an attachment unit to be attached to the user's hand; an arm rotatably supported by the attachment unit via a joint; a slide block supported on the arm and movable in a longitudinal direction of the arm and including a distance sensor for measuring a distance therefrom to the fingertip; a first actuator that drives the joint to rotate the arm; a second actuator that moves the slide block; and a control device that calculates the position of the fingertip based on the position of the distance sensor and a result of measurement by the distance sensor; and drives the first and second actuators to move the slide block to a position separated from the user's finger according to the position of the fingertip.

### TECHNICAL FIELD

The present invention relates to a measurement device configured to measure a position of a fingertip of a hand and a force feedback device for presenting a force sense to a finger.

### BACKGROUND ART

In recent years, research and development have been conducted to acquire data of motions of a finger or thumb (hereinafter also referred to simply as "finger motions") of a hand to provide assistance to an operation using the data. There are also technologies to measure finger motions for virtual reality (VR) and remote operation. For example, Patent Document 1 discloses a motion detecting device for detecting a user's finger motion, having a spherical part on which the user's hand with his/her fingers and thumb can be placed. For each of the user's fingers and thumb, a touch sensor is provided at a corresponding position of the device. The device including the spherical part is capable of measuring the finger motions with the corresponding touch sensors.

### Prior Art Documents

### PATENT DOCUMENTS

Patent Document 1: JP6891344B

### SUMMARY OF THE INVENTION

### Task to be Accomplished by the Invention

One challenge in measuring finger motions is to enable motion detection without restricting finger movement. The motion detecting device disclosed in Patent Document 1 has a problem that finger motions cannot be measured when the finger or thumb is separated from the motion detecting device. That is, in the motion detection device of Patent Document 1, a user's finger motions are restricted as the finger or thumb is required to touch the corresponding touch sensor during detection.

The present invention has been made in view of the problem of the prior art, and a primary object of the present invention is to enable measurement of finger motions without restricting a user's finger movements, thereby assisting the reduction of energy consumption of a device for measuring finger motions.

### Means to Accomplish the Task

As a solution to the above-described task to be accomplished, an aspect of the present invention provides a measurement device configured to measure a position of a fingertip, the fingertip being the distal end of a finger or thumb of a user's hand, comprising: an attachment unit to be attached to the user's hand; an arm rotatably supported by the attachment unit via a joint; a slide block supported on the arm so as to be movable in a longitudinal direction of the arm and including a distance sensor for measuring a distance therefrom to the fingertip; a first actuator for driving the joint to rotate the arm; a second actuator for moving the slide block; and a control device for controlling the first actuator and the second actuator, wherein the control device performs: a sensor position calculation operation to calculate the position of the distance sensor; a fingertip position calculation operation to calculate the position of the fingertip based on the position of the distance sensor calculated in the sensor position calculation operation and a result of measurement by the distance sensor; and a slide block movement operation to drive the first actuator and the second actuator to move the slide block to a position separated from the user's finger or thumb according to the position of the fingertip calculated in the fingertip position calculation operation.

In this configuration, the measurement device performs the slide block movement operation to move the slide block to a position separated from the user's finger or thumb, and then calculates the position of the fingertip relative to the attachment unit, using the slide block that is separated from the finger or thumb. With this configuration, since the slide block is positioned at a position separated from the finger or thumb, the measurement device can determine the position of the fingertip without restricting the user's finger movements.

As a solution to the above-described task to be accomplished, another aspect of the present invention provides a force feedback device comprising the measurement device and configured to present a force sense to the user's finger or thumb, wherein the control device further performs a force sense presentation operation to drive the first actuator and the second actuator, thereby moving the slide block to a position where the slide block is in close contact with the fingertip based on the position of the fingertip relative to the attachment unit calculated in the fingertip position calculation operation, and causing the first actuator to generate a rotational force such that a force is applied from the slide block to the fingertip.

In this configuration, the force feedback device can perform the force sense presentation operation to present force sense to the user's fingertip. When not presenting force sense to the fingertip, the force feedback device can measure the position of the fingertip with the slide block that is separated from the fingertip. When presenting force sense to the fingertip, the force feedback device can bring the slide block into close contact with the fingertip and present force sense to the fingertip via the slide block With this configuration, when not presenting force sense to the fingertip, the force feedback device does not restrict the user's finger movements, enabling proper presentation of force sense to the fingertip.

### Effect of the Invention

According to the above-described embodiments of the present invention, the measurement device is enabled to measure finger motions without restricting a user's finger movements. In addition, since the force feedback device does not restrict a user's finger movements when not presenting force sense to the user's fingertip. Thus, the embodiments of the present invention can assist the reduction of energy consumption of a device for measuring finger motions and also assist the reduction of energy consumption of a device for presenting force sense to a fingertip.

### BRIEF DESCRIPTION OF THE DRAWINGS

FIG. 1 is a diagram showing a general configuration of a force feedback device according to a first embodiment of the present invention;

FIG. 2 is a side view of an operating unit;

FIG. 3 is a top view of the operating unit;

FIG. 4 is a cross-sectional view taken along line IV-IV in FIG. 2;

FIG. 5 is a cross-sectional view taken along line V-V in FIG. 3;

FIG. 6 is a cross-sectional view of a slide block and a nut;

FIG. 7 is a block diagram showing a configuration of a force feedback device;

FIG. 8 is a side view of an operating unit attached to a finger which is in an extended state;

FIG. 9 is a side view of the operating unit attached to a finger which is slightly flexed; and

FIG. 10 is a side view of the operating unit attached to a finger which is significantly flexed.

### DESCRIPTION OF THE PREFERRED EMBODIMENTS

### First Embodiment

Embodiments of a force feedback device 1 according to a first embodiment of the present invention will be described with reference to the appended drawings. The force feedback device 1 of the first embodiment includes an operating device 2 that is attached to a user's hand and is configured to measure the position of a fingertip of the user's hand and to present force sense to the fingertip. (As used herein, the term "fingertip" refers to the distal end of a finger or thumb of a hand.) In the drawings and the following description, front, rear, up, down, left and right directions are defined relative to a user's hand when the measurement device is attached to the user's hand and the user's palm faces upward or downward.

### Configuration of Force feedback device 1

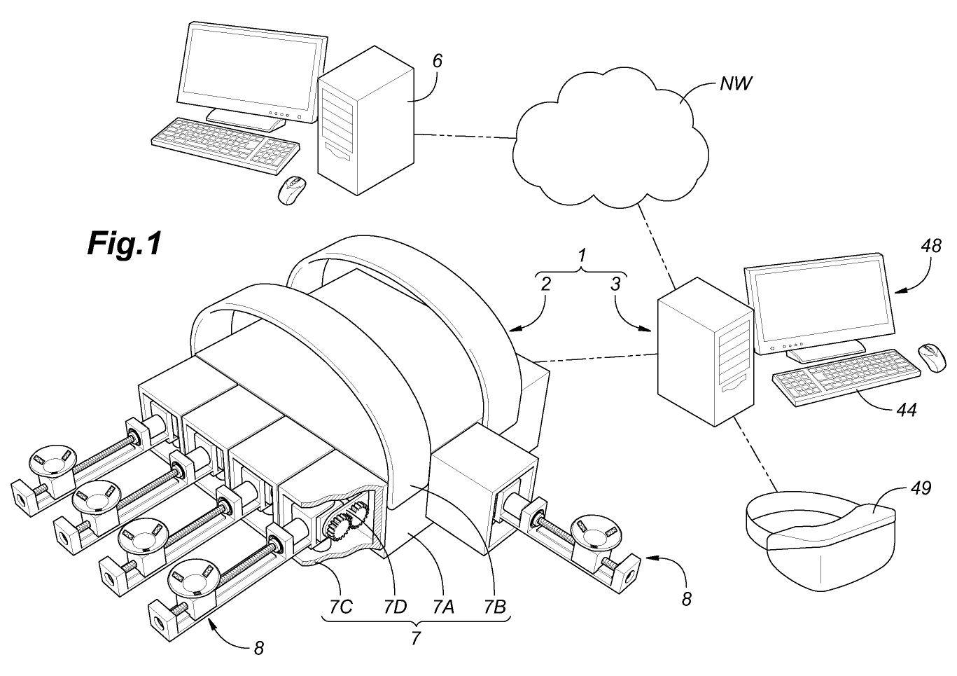

FIG. 1 is a diagram showing a general configuration of a force feedback device 1. As shown in FIG. 1, the force feedback device 1 comprises an operating device 2 and a control device 3 connected to the operating device 2. The operating device 2 is connected to the control device 3 via a wired or wireless connection. The control device 3 is connected to a network NW (e.g., the Internet) via a wired or wireless connection, which is connected to a measurement data processing device 6. The measurement data processing device 6 may be a server that generates data for a virtual space in virtual reality (VR), or may be a server that controls a remotely-operated device (e.g., a robot).

### Configuration of Operating Device 2

As shown in FIG. 1, the operating device 2 includes a case 7 (attachment unit) that can be attached to a user's hand and five operating units 8 for measuring the positions of fingertips of the user's hand and presenting force sense to the fingertips. The case 7 includes a rectangular prism-shaped main body 7A, two bands 7B attached to the main body 7A, five attachment portions 7C fixed to the main body 7A, each being in the shape of a bottomed rectangular cylinder, and five bases 7D fixed to each of the five attachment portions 7C. Each of the operating units 8 is attached to a corresponding attachment portion 7C and base 7D. Each of the bases 7D may be fixed to a corresponding attachment portion 7C, using fastening members such as a bolt and nut.

A user can insert the user's hand between the main body 7A and bands 7B to wear the operating device 2. When the operating device 2 is worn, the case 7 and the five operating units 8 are positioned on the user's palm side. The five operating units 8 are positioned at locations corresponding to the user's fingers and thumb. Since each of the five operating units 8 has a similar configuration, the following description pertains to one of the operating units 8. Furthermore, the following description of the operating unit 8 pertains to a state in which the user's fingers and thumb extend straight frontward and the arm 12 of the operating unit 8, described later, extends in the front-rear direction.

### Configuration of Operating Unit 8

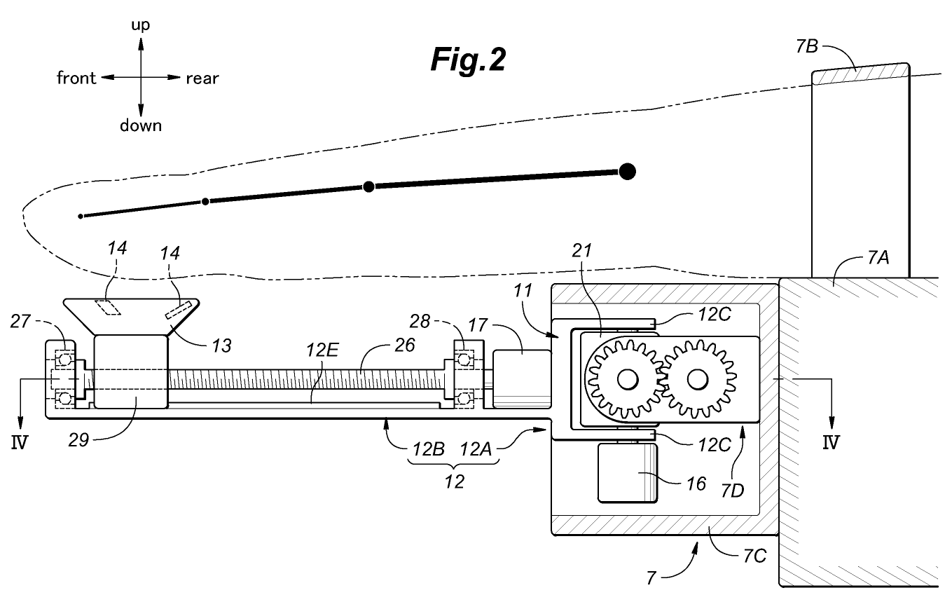

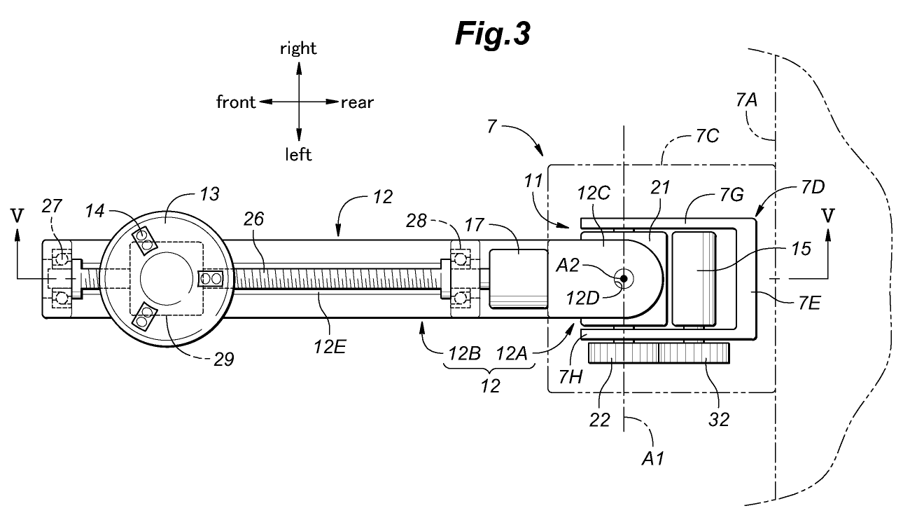

FIG. 2 is a side view of the operating unit 8. FIG. 3 is a top view of the operating unit 8. As shown in FIGS. 2 and 3, each operating unit 8 includes: an arm 12 rotatably supported by the base 7D of the case 7 via a joint 11; a slide block 13 movably supported on the arm 12; a distance sensor 14 having a plurality of distance sensor elements provided on the slide block 13; a first motor 15 and a second motor 16 (first actuator) for driving the joint 11 to rotate the arm 12; and a third motor 17 (second actuator) for moving the slide block 13.

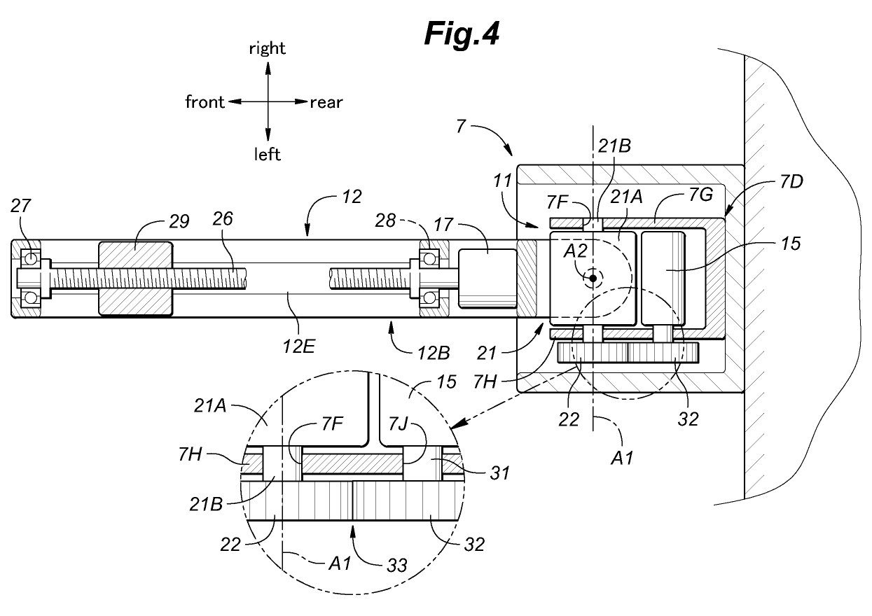

As shown in FIG. 3, the base 7D of the case 7 includes: a rear plate portion 7E, which is a plate-shaped element coupled to the attachment portion 7C (FIG. 2) and has its surfaces facing the front-rear direction; a right plate portion 7G which is a plate-shaped element extending frontward from the right end of the rear plate portion 7E; a left plate portion 7H which is a plate-shaped element extending frontward from the left end of the rear plate portion 7E; and through holes 7F (FIG. 4) formed in both the right plate portion 7G and the left plate portion 7H, extending in the left-right direction. The right plate portion 7G and the left plate portion 7H are parallel to each other and, as shown in FIG. 2, are formed with a front edge having a semi-circular shape. Each of the right plate portion 7G and the left plate portion 7H has the through hole 7F in the front part thereof (FIG. 4). The left plate portion 7H has a through hole 7J (FIG. 4) extending in the left-right direction in the rear part thereof.

As shown in FIG. 3, the arm 12 extends in the front-rear direction (a longitudinal direction of the arm). The arm 12 includes a connection portion 12A, which is part of the joint 11, at the rear part thereof, and a rail portion 12B extending frontward from the connection portion 12A.

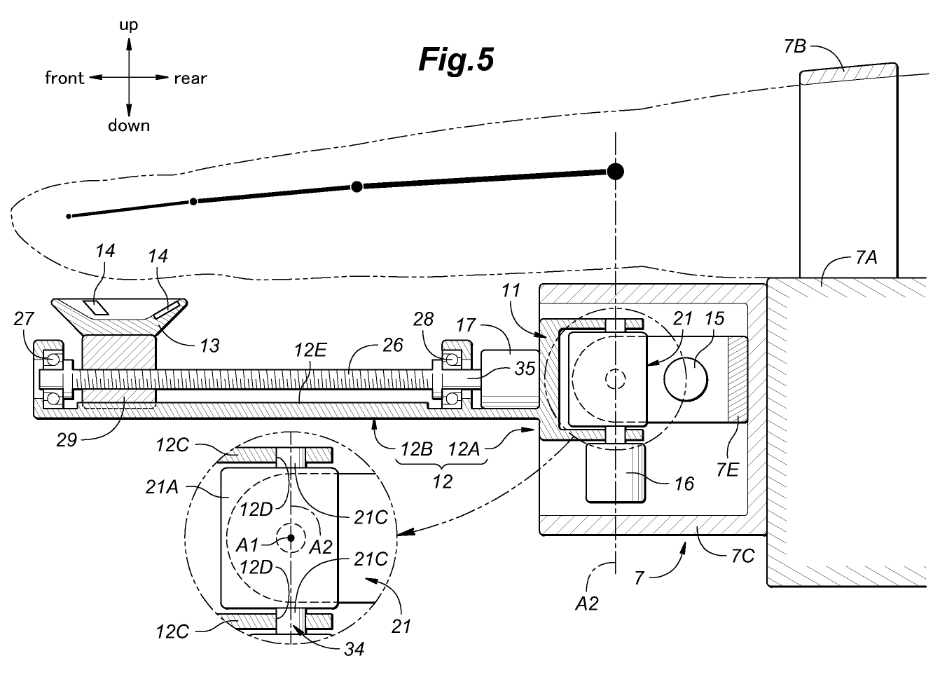

The connection portion 12A has two plate sections 12C that face each other and have their semicircular rear ends, each plate section 12C having a through hole 12D formed therein (FIG. 5).

As shown in FIG. 3, the joint 11 includes the right plate portion 7G and left plate portion 7H of the base 7D of the case 7; the two plate sections 12C of the arm 12; and the connecting member 21 that connects the right plate portion 7G and left plate portion 7H to the two plate sections 12C.

FIG. 4 is a cross-sectional view taken along line IV-IV in FIG. 2. FIG. 5 is a cross-sectional view taken along line V-V in FIG. 3. As shown in FIGS. 4 and 5, the connecting member 21 includes a main body 21A formed in a cubic shape, and a first shaft 21B (FIG. 4) and a second shaft 21C (see FIG. 5) extending out from the main body 21A. The main body 21A is positioned between the right plate portion 7G and the left plate portion 7H of the base 7D of the case 7, and between the two plate sections 12C of the arm 12.

As shown in FIG. 4, the first shaft 21B extends in a first direction (the left-right direction in FIGS. 2 to 5) that intersects with the longitudinal direction of the arm 12. The first shaft 21B is inserted through the through holes 7F in the right plate portion 7G and the left plate portion 7H of the base 7D. This configuration allows the connecting member 21 and the base 7D of the case 7 to be connected to each other to be rotatable about a first rotational axis A1 extending in the first direction of the first shaft 21B. A gear 22 is coupled to the left end of the first shaft 21B.

As shown in FIG. 5, the second shaft 21C extends from the main body 21A in a second direction (an up-down direction in FIGS. 2 to 5) that intersects with the longitudinal direction of the arm 12 and the first direction. The second shaft 21C is inserted through the through holes 12D in the two plate sections 12C of the arm 12. As a result, the connecting member 21 and the connection portion 12A of the arm 12 are connected to each other to be rotatable about a second rotational axis A2 extending in the second direction of the second shaft 21C.

As described above, the joint 11 is a universal joint having the connecting member 21, which is rotatably connected to case 7 to be rotatable about the first rotational axis A1 extending in the first direction (FIG. 4) and is rotatably connected to arm 12 to be rotatable about the second rotational axis A2 extending in the second direction (FIG. 5).

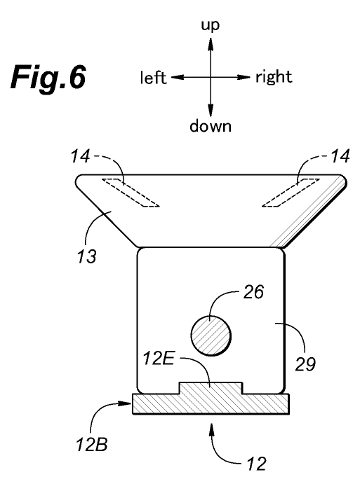

As shown in FIGS. 2 and 3, the rail portion 12B has a plate-like shape. A guide portion 12E (FIGS. 4 and 6) protrudes upward in a width-wise central part of the rail portion 12B. Furthermore, a feed screw is provided on the rail portion 12B. Specifically, the rail portion 12B includes: a screw shaft 26 with male threads formed on its outer surface; a bearing 27 rotatably supporting a front end part of the screw shaft 26; a bearing 28 rotatably supporting a rear end part of the screw shaft 26; and a nut 29 engaged with the screw shaft 26. The bearings 27 and 28 may be bearings capable of supporting radial and axial loads. The bearings 27 and 28 may be, for example, tapered roller bearings or angular contact ball bearings. In some cases, a ball screw may be provided on the rail portion 12B.

FIG. 6 is a cross-sectional view of the slide block 13 and the nut 29. As shown in FIG. 6, the slide block 13 is coupled to the upper side of the nut 29. The slide block 13 is formed in a dish-like shape that expands in diameter toward the upward direction. As shown in FIGS. 3 to 5, when the screw shaft 26 rotates, the nut 29 moves in the front-rear direction guided by the guide portion 12E. The guide portion 12E supports the nut 29 and guides its movement in the front-rear direction. The nut 29 moves in the front-rear direction together with the slide block 13. Thus, the slide block 13 is supported by the arm 12 so that the slide block 13 can move in the longitudinal direction of the arm 12.

As shown in FIG. 3, a distance sensor 14 has a plurality (three) of distance sensor elements which are provided on the upper surface of the slide block 13, and arranged at intervals in the circumferential direction. The distance sensor 14 is provided to measure the position of a fingertip relative to the slide block 13 and is capable of measuring the distance between the fingertip and the distance sensor 14. The distance sensor 14 is a proximity sensor that detects a distance, and the type thereof is not limited. The distance sensor 14 may be an ultrasonic proximity sensor, an optical proximity sensor, or a capacitive proximity sensor. The number of distance sensor elements of the distance sensor 14 is not limited, but the distance sensor 14 with three or more distance sensor elements is preferably used to facilitate accurate measurement of the position of the fingertip relative to the slide block 13.

As shown in FIG. 4, the first motor 15 is positioned between the right plate portion 7G and the left plate portion 7H of the base 7D of the case 7 and is fixed to the right plate portion 7G and the left plate portion 7H. The first motor 15 has a first output shaft 31 extending in the first direction. The first output shaft 31 is inserted through the through hole 7J in the left plate portion 7H, and a gear 32 is coupled to an end of the output shaft 31. The gear 32 meshes with the gear 22. The gear 22 and the gear 32 form a reducer 33 having a reduction ratio ranging from 1 to 10.

The gear 22 is coupled to the first shaft 21B of the connecting member 21, which is part of the joint 11. The gear 32 is coupled to the first output shaft 31 of the first motor 15, which is fixed to the base 7D. Thus, the first motor 15 (first actuator) is connected to the joint 11 via the reducer 33, which has a low reduction ratio of 1 to 10. When the first motor 15 rotates the first output shaft 31, the arm 12, together with the connecting member 21, rotates about the first rotational axis A1 relative to the base 7D of the case 7. In other words, when the first motor 15 rotates the first output shaft 31, the arm 12 rotates up and down about the first rotational axis A1.

In the present embodiment, the first output shaft 31 of the first motor 15 is coupled to the first shaft 21B of the connecting member 21 via the reducer 33 (gear 22 and gear 32). However, in some cases, the reducer 33 (gears 22 and 32) may not be provided. That is, the first output shaft 31 of the first motor 15 may be directly coupled to the first shaft 21B of the connecting member 21.

As shown in FIG. 5, the second motor 16 is positioned below the lower plate section 12C of the connection portion 12A of the arm 12 and is fixed to the lower plate section 12C. The second motor 16 has a second output shaft 34 extending coaxially with the second rotational axis A2. The second output shaft 34 is inserted through the through holes 12D in the lower plate section 12C and is integrally coupled to the second shaft 21C of the connecting member 21. When the second motor 16 rotates the second output shaft 34, the arm 12 rotates about the second rotational axis A2 relative to the connecting member 21. That is, when the second motor 16 rotates the second output shaft 34, the arm 12 rotates left and right about the second rotational axis A2.

The third motor 17 is coupled to the rear end of the rail portion 12B. The third motor 17 has a third output shaft 35 coupled to the screw shaft 26. When the third motor 17 rotates the third output shaft 35, the screw shaft 26 rotates, causing the slide block 13 to move in the front-rear direction together with the nut 29 that is engaged with the screw shaft 26. That is, when the third motor 17 rotates the third output shaft 35, the slide block 13 moves in the front-rear direction.

In the present embodiment, the operating unit 8 includes the nut 29 coupled to the slide block 13, the feed screw (screw shaft 26 and nut 29) provided on the rail portion 12B, and the third output shaft 35 of the third motor 17 coupled to the screw shaft 26, which cooperatively cause the slide block 13 to move. In other embodiments, a timing belt or wire may be used instead of the feed screw to move the slide block 13 in the front-rear direction. In this case, the slide block 13 is provided with a slider that is guided in the front-rear direction within the guide portion 12E instead of the nut 29, the slider being connected to the third output shaft 35 of the third motor 17 via a timing belt or wire. In this configuration, rotation of the third output shaft 35 causes the slider and the slide block 13 to move together with the timing belt or wire.

### Configuration of Control Device 3

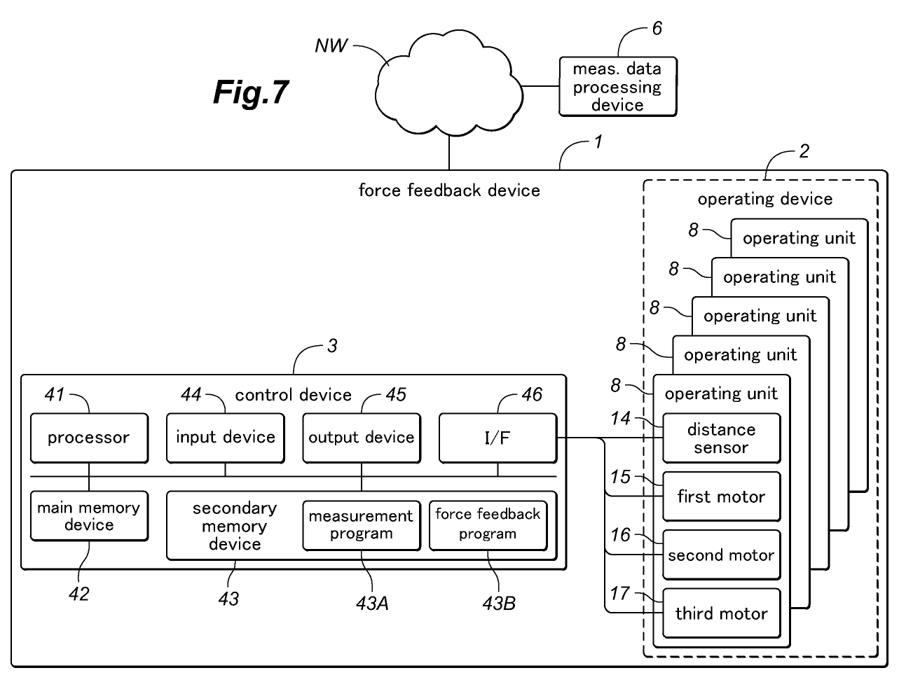

FIG. 7 is a block diagram showing a configuration of the force feedback device 1. As shown in FIG. 7, the control device 3 includes a processor 41, a main memory device 42, a secondary memory device 43, an input device 44, an output device 45, and an interface (I/F) 46. The control device 3 may also be a microcontroller unit (MCU) provided in the case 7. The control device 3 and the measurement data processing device 6 can be implemented by using general-purpose information processing devices such as a PC and a server computer.

The main memory device 42 and the secondary memory device 43 store data and programs that are executable by the processor 41. The processor 41 reads data and programs stored in the secondary memory device 43 into the main memory device 42 and executes the read programs to perform corresponding processing operations. The main memory device 42 includes RAM, ROM, and other devices with volatile memory elements. The secondary memory device 43 includes HDD (Hard Disk Drive) and SSD (Solid State Drive), which have non-volatile memory elements.

The secondary memory device 43 stores a measurement program 43A and a force feedback program 43B. The measurement program 43A is a program for executing a measurement operation to measure finger motions, and the force feedback program 43B is a program for performing a force sense presentation operation to present force sense to a user's fingertip(s).

The input device 44 is a device for receiving a user's operations, such as a keyboard or mouse (FIG. 1). The control device 3 may not necessarily include the input device 44. The output device 45 is a device for outputting information, such as a display or speaker. The control device 3 includes a display 48 (FIG. 1) for presenting images as the output device 45, and a head-mounted display 49 (FIG. 1) to be worn on a user's head and present images.

The interface (I/F) 46 is an interface (transceiver) that is connected to a network NW and to the distance sensor 14, first motors 15, second motors 16, and third motors 17 of all measuring units (operating units), and is capable of transmitting and receiving data. The processor 41 can transmit and receive data to and from the measurement data processing device 6 via the network NW, using the I/F 46. The processor 41 can acquire output data from the distance sensors 14 of all the measuring units, using the I/F 46. Furthermore, the processor 41 can output control signals to the first motor 15, second motor 16, and third motor 17 of each measuring unit to generate rotational forces corresponding to the control signals.

### Finger Motion Measurement and Force Sense Presentation

The force feedback device 1 measures the position of a user's fingertip and presents force sense to the fingertip while transmitting and receiving information to and from the measurement data processing device 6. Generally, fingertips are used in many tasks to be done by the user. Thus, changes in the fingertip position indicate finger motions, and to measure the relative position of fingertip enables measurement of finger motions. As described above, the measurement data processing device 6 may be a server that generates data for a virtual space in virtual reality (VR), or a server that controls a remotely operated target device (e.g., a robot). As shown in FIG. 1, the control device 3 includes the head-mounted display 49. The user can wear the head-mounted display 49.

The control device 3 performs a fingertip position transmission operation to measure the destination position of the fingertip, and to transmit information indicating the position of the fingertip relative to the case 7, such as coordinates (hereinafter referred to as "fingertip position information"), to the measurement data processing device 6. The measurement data processing device 6 generates data containing image data of the surroundings of a user's hand (hereinafter referred to as "surrounding image information") based on the fingertip position information received from the control device 3, and transmits the generated surrounding image information to the control device 3. When the measurement data processing device 6 is a server that controls a device to be remotely operated (e.g., a robot), the measurement data processing device 6 operates the target device based on the received fingertip position information.

The control device 3 performs an image indication operation to generate an image indicating a user's finger and its surrounding state based on the received surrounding image information, and to display the image on the head-mounted display 49. This configuration allows a user to move the user's fingers and/or thumb while viewing the images displayed on the head-mounted display 49.

The measurement data processing device 6 calculates information representing force sense to be presented to the fingertip (e.g., information on the direction and magnitude of a force applied to the fingertip, hereinafter referred to as "force sense information") in response to an event, such as when a user's finger touches an object (an object in a virtual space or an operable device), and transmits the calculated force sense information to the control device 3. The control device 3 uses the slide block 13 to present force sense to the user's fingertip based on the received force sense information.

As described below, the measurement of the position of a fingertip involves the following steps: (1) A first step is to initialize the operating device 2, control device 3, and measurement data processing device 6. (2) A second step is to measure finger motions by using the force feedback device 1. (3) A third step is to present the force sense to the fingertip when the control device 3 receives force sense information from the measurement data processing device 6.

(1) Initialization of the operating device 2, control device 3, and measurement data processing device 6.

In this step, the control device 3 transmits information indicating that initialization is starting to the measurement data processing device 6. A user wears the head-mounted display 49 and the operating device 2. As described below, the user places the user's fingers corresponding to the operating units 8 in a finger reference state. The operating units 8 are then set to a unit reference state.

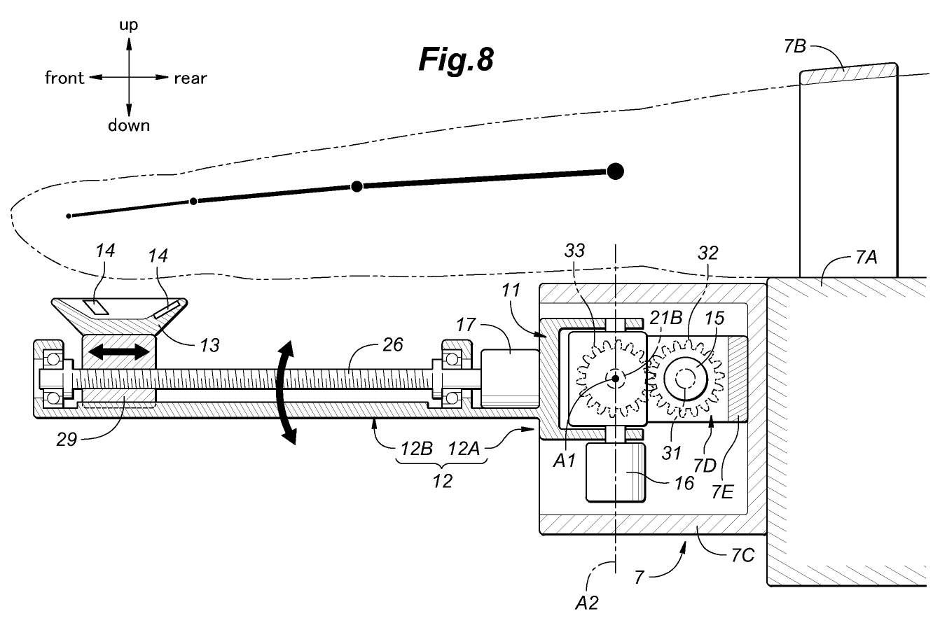

FIG. 8 is a side view of an operating unit 8 attached to a finger which is in an extended state. FIG. 8 shows the finger reference state, and the unit reference state of the operating unit 8. The finger reference state is defined as a state where a user's finger is extended frontward while the user's palm faces downward. In some cases, a state other than this state may be defined as the finger reference state. The unit reference state of an operating unit 8 is when the operating unit 8 is attached to the corresponding finger in its finger reference state, and its arm 12 extends in the front-rear direction below the finger. In some cases, a state other than this state may also be determined as the unit reference state of an operating unit 8.

As described above, the control device 3 can output control signals to the first motor 15, second motor 16, and third motor 17 of each of all the operating units 8 to generate rotational forces corresponding to the control signals. When the first motor 15 rotates the first output shaft 31, the arm 12 rotates up and down about the first rotational axis A1. When the second motor 16 rotates the second output shaft 34, the arm 12 rotates left and right about the second rotational axis A2. Furthermore, when the third motor 17 rotates the third output shaft 35, the slide block 13 moves in the front-rear direction.

As the arm 12 rotates about the first rotational axis A1, an angular position in the rotation of the arm 12 relative to the case 7 (the angle in the up-down rotation of the arm 12) about the first rotational axis A1, is referred to as an "up-down rotational position θ." The up-down rotational position θ may be defined such that the up-down rotational position θ₀ in the unit reference state of an operating unit 8 (where the arm 12 extends frontward) is set to 0 (the up-down rotational position θ₀ = 0). The control device 3 can output a control signal to the first motor 15 to change the up-down rotational position θ of the arm 12. Furthermore, the control device 3 can calculate the current up-down rotational position θ of the arm 12 based on information about the change amount of the up-down rotational position θ contained in the control signal transmitted to the first motor 15. The current up-down rotational position θ is the sum of the change amounts of the up-down rotational position θ contained in the control signals transmitted to the first motor 15 up to the present.

As the arm 12 rotates about the second rotational axis A2, an angular position in the rotation of the arm 12 relative to the case 7 (the angle in the left-right rotation of the arm 12) about the second rotational axis A2, is referred to as an "left-right rotational position θ." The left-right rotational position θ may be defined such that the left-right rotational position θ₀ in the unit reference state of an operating unit 8 (where the arm 12 extends frontward) is set to 0 (the left-right rotational position θ₀ = 0). The control device 3 can output a control signal to the second motor 16 to change the left-right rotational position θ of the arm 12. Furthermore, the control device 3 can calculate the current left-right rotational position θ of the arm 12 based on information about the change amount of the left-right rotational position θ contained in the control signal transmitted to the second motor 16. The current left-right rotational position θ is the sum of the change amounts of the left-right rotational position θ contained in the control signals transmitted to the second motor 16 up to the present.

The distance sensor 14 is provided on the slide block 13. The relative position rS of the slide block 13 with respect to the arm 12 is defined as the relative position rS of the distance sensor 14 with respect to the arm 12 (the relative position rS of the slide block 13 with respect to the arm 12 = the relative position rS of the distance sensor 14 with respect to the arm 12). The relative position rS of the slide block 13 with respect to the arm 12 may be defined such that the relative position rS0 of the slide block 13 is 0 with respect to arm 12 in the unit reference state of the operating unit 8 (the relative position rS0 of the distance sensor 14 = 0). The control device 3 can output a control signal to the third motor 17 to change the relative position rS of the distance sensor 14 with respect to the arm 12. Furthermore, the control device 3 can calculate the current relative position rS of the distance sensor 14 with respect to the arm 12 based on the information on the change in the relative position rS of the distance sensor 14 with respect to the arm 12 contained in the control signal transmitted the third motor 17. The current relative position rS of the distance sensor 14 with respect to the arm 12 is the sum of the changes in the relative position rS of the distance sensor 14 with respect to the arm 12 contained in the control signals transmitted to the third motor 17 up to the present.

The control device 3 can calculate the relative position rF of the fingertip relative to the distance sensor 14 based on the output of the distance sensor 14. The relative position rF is a measurement result of the distance sensor 14.

For each of the distance sensors 4, the control device 3 measures the relative position of a corresponding fingertip or thumbtip relative to the distance sensor 14 (referred to as the "reference fingertip position rFs") from the output of the distance sensor 14, based on the finger reference state of the finger or thumb and the unit reference state of the corresponding operating unit 8. Furthermore, the control device 3 calculates the position of the fingertip relative to the case 7 from the reference fingertip position rFs. Furthermore, control device 3 calculates the position of the fingertip relative to case 7 from reference fingertip position rFs. Furthermore, the control device 3 calculates the position of the fingertip relative to the case 7 from the reference fingertip position rFs, generates fingertip position information indicating the calculated fingertip position, and performs a fingertip position transmission operation to transmit the generated fingertip position information to the measurement data processing device 6. The measurement data processing device 6 sets the fingertip position relative to the finger reference state of the finger based on the received fingertip position indication information. Then, the measurement data processing device 6 generates data containing image information about the user's hand surroundings (surrounding image information) based on the set fingertip position and transmits the generated surrounding image information to the control device 3. The control device 3 performs an image indication operation to generate an image showing the state of the user's finger and its surroundings based on the received surrounding image information, and to display the generated image on the head-mounted display 49.

The control device 3 is capable of calculating the current up-down rotational position θ of the arm 12 based on the up-down rotational position θ₀ of the arm 12 in the unit reference state of the operating unit 8 and the control signal transmitted to the first motor 15. The control device 3 is capable of calculating the current left-right rotational position φ of the arm 12 based on the left-right rotational position φ₀ of the arm 12 in the unit reference state of the operating unit 8 and the control signal sent to second motor 16. Furthermore, the control device 3 is capable of calculating the current relative position rS of the distance sensor 14 with respect to the arm 12 based on the relative position rS0 of the distance sensor 14 with respect to the arm 12 in the unit reference state of the operating unit 8 and the control signal transmitted to the third motor 17.

When executing the measurement program 43A, the control device 3 performs a measurement operation defined by the instructions of the measurement program 43A. The measurement operation includes a sensor position calculation operation, a fingertip position calculation operation, and a slide block movement operation, which will be described below. When executing the force feedback program 43B, the control device 3 performs the force sense presentation operation defined by the instructions of the force feedback program 43B.

The control device 3 is capable of performing a sensor position calculation operation to calculate the position S of the distance sensor 14 relative to the case 7, based on the current up-down rotational position θ and the left-right rotational position φ of the arm 12, and the current relative position rS of the distance sensor 14 with respect to the arm 12. The up-down rotational position θ and left-right rotational position φ of arm 12 represent the rotational positions of the arm 12.

The control device 3 is capable of calculating the relative position rF of the fingertip with respect to the corresponding distance sensor 14 based on the output of the distance sensor 14. The relative position rF is a measurement result of the distance sensor 14. The control device 3 is capable of performing a fingertip position calculation operation to calculate the position F of the fingertip relative to the case 7 based on the position S of the distance sensor 14 (the position of the distance sensor 14 relative to the case 7) calculated in the sensor position calculation operation, and the relative position rF of the fingertip relative to the distance sensor 14.

### 2 Measurement of finger motions.

In this step, for each of the distance sensors 4, the control device 3 measures the distance between the distance sensor 14 and a corresponding fingertip based on the output of the distance sensor 14 at predetermined time intervals (e.g., 1 ms). Next, the control device 3 determines whether the distance between the distance sensor 14 and the fingertip has changed. To detect a change in the distance between the distance sensor 14 and the fingertip is to detect that a user moves the user's finger or thumb, thereby changing the position of the fingertip.

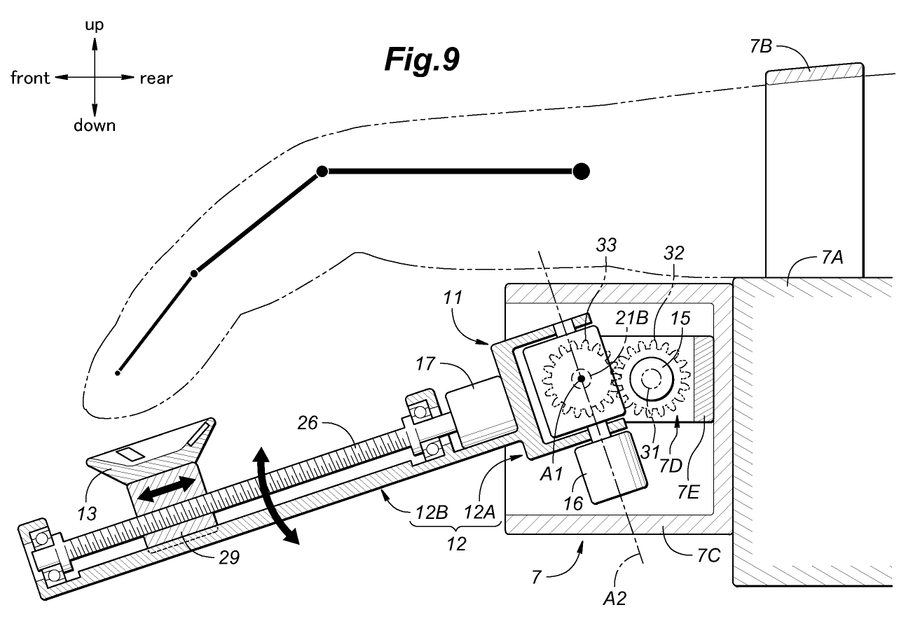

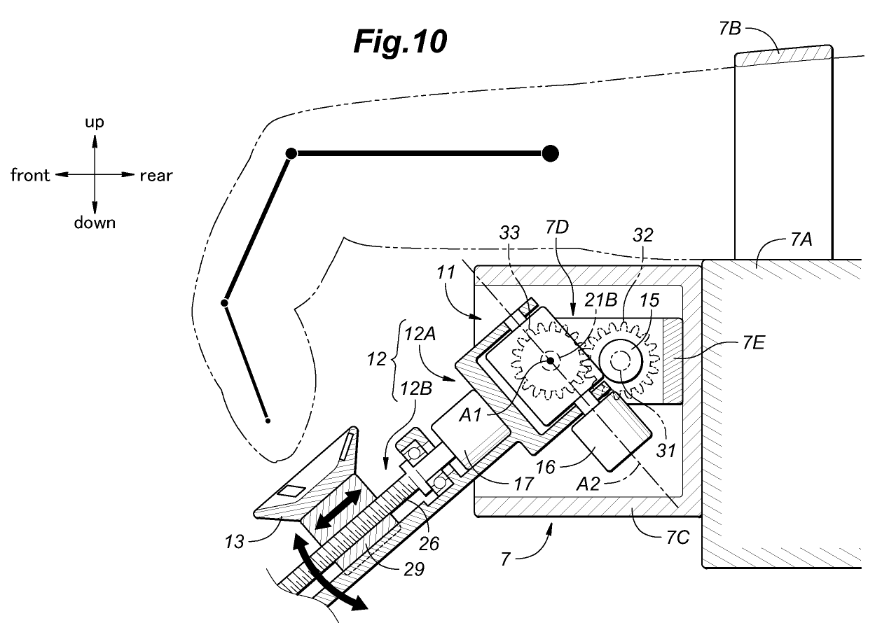

FIG. 9 is a side view of the operating unit 8 attached to a finger which is slightly flexed. FIG. 10 is a side view of the operating unit 8 attached to a finger which is significantly flexed. As shown in FIGS. 9 and 10, the control device 3 moves a slide block 13 up and down in response to the movement of a corresponding fingertip in the vertical direction. Furthermore, the control device 3 moves the slide block 13 left and right in response to the movement of the fingertip in the horizontal direction.

When the control device 3 determines that the distance between the distance sensor 14 and the fingertip has changed, the control device 3 calculates the relative position rF of the fingertip with respect to the distance sensor 14 (slide block 13) based on the output of the distance sensor 14. Then, the control device 3 calculates the current up-down rotational position θ and left-right rotational position φ of the arm 12, and the current relative position rS of the distance sensor 14 with respect to the arm 12, based on control signals output to the first motor 15, second motor 16, and third motor 17. Next, the control device 3 performs a sensor position calculation operation to calculate the position S of the distance sensor 14 relative to the case 7 based on the current up-down rotational position θ and left-right rotational position φ of the arm 12, and the current relative position rS of distance sensor 14 relative to the arm 12. Next, the control device 3 performs a fingertip position calculation operation to calculate the position F of the fingertip relative to the case 7 based on the calculated position S of the distance sensor 14 relative to the case 7 and the calculated relative position rF of the fingertip relative to the distance sensor 14 (slide block 13). The control device 3 generates fingertip position information from the calculated fingertip position F relative to the case 7 and performs a fingertip position transmission operation to transmit the generated fingertip position information to the measurement data processing device 6.

Next, the control device 3 performs a slide block movement operation to drive the first motor 15, second motor 16, and third motor 17 to thereby move the slide block 13 to a position separated from the finger, according to the position F of the fingertip relative to the case 7 calculated in the fingertip position calculation operation. In the slide block movement operation, the control device 3 first calculates the position to which slide block 13 is to be moved (referred to as the "destination position vrS") based on the position F of the fingertip relative to the case 7. The destination position vrS is a position where the slide block 13 is separated from the finger and located at least a predetermined distance away from the fingertip. Next, the control device 3 outputs control signals to drive the first motor 15, second motor 16, and third motor 17, causing the slide block 13 to move to the destination position vrS. As a result, the slide block 13 moves to the position separated from the finger (destination position vrS).

The measurement of a finger motion by using the force feedback device 1 has been described. As described above, in the measurement of finger motions, when a finger or thumb of a user moves, the control device 3 calculates the relative position rF of the fingertip with respect to the distance sensor 14 (slide block 13), and then performs the sensor position calculation operation and the fingertip position calculation operation to thereby calculate the position F of the fingertip relative to the case 7. Next, the control device 3 transmits the position F of the fingertip relative to the case 7 (fingertip position information) to the measurement data processing device 6. The measurement data processing device 6 generates surrounding image information based on the received fingertip position information and transmits the surrounding image information to the control device 3. The control device 3 receives the surrounding image information, performs an image indication operation to update the image displayed on the head-mounted display 49. Then, the control device 3 performs a slide block movement operation to move the slide block 13 to a position separated from the finger, according to the position F of the fingertip relative to the case 7 calculated in the fingertip position calculation operation. Thus, as shown in FIGS. 8 to 10, the force feedback device 1 can measure the fingertip position while maintaining the slide block 13 separated from the fingertip.

### 3 Presentation of force sense.

In this step, the measurement data processing device 6 transmits force sense information (i.e., information representing the direction and magnitude of a force applied to a user's fingertip (force sense)) to control device 3 in response to an event, such as when the user's finger touches an object (an object in a virtual space or an operable device). The control device 3 performs a force sense presentation operation to present force sense to the user's fingertip based on the received force sense information. In the force sense presentation operation, the control device 3 drives the first motor 15, second motor 16, and third motor 17 to move the slide block 13 to a position where the slide block is in close contact with the fingertip based on the position F of the fingertip relative to the case 7 (attachment unit) calculated in the fingertip position calculation operation, and the control device 3 then causes the first motor 15 and second motor 16 (first actuator) to generate rotational forces so that force is applied from the slide block 13 to the fingertip. The control device 3 outputs control signals to the first motor 15 and second motor 16 to drive the first motor 15 and second motor 16 such that the direction and magnitude of a force applied from the slide block 13 to the fingertip correspond to the direction and magnitude of the force (force sense) applied to the user's fingertip contained in the force sense information.

Next, effects achieved by the force feedback device 1 will be described.

The force feedback device 1 performs a slide block movement operation to move the slide block 13 to a position separated from the user's finger or thumb, and then calculates the position F of the fingertip relative to the case 7, using the slide block 13 that is separated from the finger. With this configuration, since the slide block 13 is positioned at a position separated from the finger or thumb, the force feedback device 1 can determine the position of the fingertip without restricting the user's finger movements. Furthermore, when not presenting force sense to the fingertip, the force feedback device does not restrict the user's finger movements.

The case 7 (attachment unit) is positioned on a side of the user's palm, while the arm 12 is positioned on a side of a ball of the user's finger or thumb. This configuration facilitates the placement of the slide block 13 at a position separated from the user's finger or thumb.

The first motor 15 (first actuator) is connected to the joint 11 via the reducer 33 with a low reduction ratio, enabling the driving force of the first motor 15 (first actuator) to rotate the joint 11 with low inertia. This enables the arm 12 to rotate with good time responsiveness, thereby moving the slide block 13 with good time responsiveness. This configuration allows the slide block 13 be moved to a position quickly without restricting the user's finger movement. This configuration also allows force sense to be presented to the fingertip more quickly.

The joint 11 is a universal joint. This feature allows the joint 11 to rotate about both the first rotational axis A1 and the second rotational axis A2, while also enabling the joint 11 to be made compact. Furthermore, the first rotational axis A1 and the second rotational axis A2 intersect with each other, which facilitates calculation of the rotational positions of the arm 12 (up-down rotational position θ and left-right rotational position φ).

Using the first motor 15 and the second motor 16 facilitates a proper rotation of the arm 12.

The force feedback device 1 is capable of performing the force sense presentation operation to present force sense to the fingertip. When not presenting force sense to the fingertip, the force feedback device 1 measures the fingertip's position with the slide block 13 that is separated from the fingertip. When presenting force sense to the fingertip, the force feedback device can bring the slide block 13 into close contact with the fingertip and present force sense to the fingertip via the slide block 13. With this configuration, when not presenting force sense to the fingertip, the force feedback device 1 does not restrict the user's finger movements, enabling proper presentation of force sense to the fingertip.

The control device 3 is connected to the measurement data processing device 6 via the network NW and performs the fingertip position transmission operation. The measurement data processing device 6 connected to the network NW receives fingertip position information, uses the fingertip position information to calculate the position of the fingertip, and transmits the force sense information to the control device 3, enabling the control device 3 to present force sense to the fingertip. This configuration facilitates the measurement of finger motions and the presentation of force sense to the fingertip by using the force feedback device 1.

The force feedback device 1 includes the head-mounted display 49, and the control device 3 performs the image indication operation to display images of the surroundings of a user's hand generated by the measurement data processing device 6, on the head-mounted display 49. This configuration allows a user to easily recognize a state of the surroundings of the user's hand calculated by the measurement data processing device 6, allowing the user to move the fingers in a proper manner.

### Second Embodiment; Measurement device

A measurement device of a second embodiment of the present invention differs from the force feedback device 1 of the first embodiment in that the control device 3, which is used in the first embodiment, does not perform the force sense presentation operation. Specifically, the measurement device of the second embodiment includes an operating device 2 and a control device 3, where the secondary memory device 43 of the control device 3 does not store the force feedback program 43B. The other features and/or configurations of the measurement device of the second embodiment are the same as those of the force feedback device 1 of the first embodiment.

The present invention has been described in terms of specific embodiments, but is not limited by such embodiments, and can be embodied with various modifications. Various changes may be made to features of the embodiments such as specific configuration, position, and quantity of each component or element thereof without departing from the scope of the present invention. In the above-described embodiments, not all elements included therein are essential, and some of them may be eliminated or replaced as appropriate. For example, the operating device 2 shown in FIG. 1 is connected to the control device 3 connected to the network NW, but the operating device 2 may also be connected to a control device that is not connected to the network NW. In some cases, the operating device 2 may be connected to a microcontroller unit (MCU) provided in a device(s) to be controlled (e.g., a robotic hand) and used to control the device to be controlled. Although operating device 2 shown in FIG. 1 includes five operating units 8, there is no limitation on the number of operating units 8 provided in the operating device 2. For example, the operating device 2 may include four operating units 8.

### Summary of Embodiments

The above-described embodiments of the present invention are summarized as follows.

One aspect of the present invention provides a measurement device configured to measure a position of a fingertip, the fingertip being the distal end of a finger or thumb of a user's hand, comprising: a case 7 (attachment unit) to be attached to the user's hand; an arm 12 rotatably supported by the case 7 via a joint 11; a slide block 13 supported on the arm 12 so as to be movable in a longitudinal direction of the arm 12 and including a distance sensor 14 for measuring a distance therefrom to the fingertip; a first motor 15 and a second motor 16 (first actuator) for driving the joint 11 to rotate the arm 12; a third motor 17 (second actuator) for moving the slide block 13; and a control device 3 for controlling the first and second motors 15, 16, and the third motor 17, wherein the control device 3 performs: a sensor position calculation operation to calculate the position S of the distance sensor 14; a fingertip position calculation operation to calculate the position F of the fingertip based on the position S of the distance sensor 14 calculated in the sensor position calculation operation and a result of measurement by the distance sensor 14; and a slide block movement operation to drive the first motor 15, second motor 16, and third motor 17 to move the slide block 13 to a position separated from the user's finger or thumb according to the position F of the fingertip calculated in the fingertip position calculation operation.

In this configuration, the measurement device performs the slide block movement operation to move the slide block 13 to a position separated from the user's finger or thumb, and then calculates the position F of the fingertip relative to the case 7, using the slide block 13 that is separated from the finger or thumb. Since the slide block 13 is positioned at a position separated from the finger or thumb, enabling the measurement device to measure the position of the fingertip without restricting the user's finger movements.

In some embodiments, the control device 3 performs a sensor position calculation operation to calculate the position S of the distance sensor 14 relative to the case 7 (attachment unit), based on the current up-down rotational position θ and the left-right rotational position φ of the arm 12 (rotational positions of the arm 12), and the current relative position rS of the distance sensor 14 with respect to the arm 12; a fingertip position calculation operation to calculate the position F of the fingertip relative to the case 7 based on the position S of the distance sensor 14 relative to the case 7 calculated in the sensor position calculation operation, and a result of measurement of the distance sensor 14; and a slide block movement operation to drive the first and second motors 15, 16 (first actuator), and the third motor 17 (second actuator) to thereby move the slide block 13 to a position separated from the finger, according to the position F of the fingertip relative to the case 7 calculated in the fingertip position calculation operation.

In this configuration, the measurement device performs the slide block movement operation to move the slide block 13 to a position separated from the finger, and uses the slide block 13 to calculate the position F of the fingertip relative to the case 7. With this configuration, since the slide block 13 is positioned at a position separated from the finger or thumb, the measurement device can determine the position of the fingertip without restricting the user's finger movements.

In some embodiments, the case 7 (attachment unit) is positioned on a side of the user's palm, while the arm 12 is positioned on a side of a ball of the user's finger or thumb.

This configuration facilitates the placement of the slide block 13 at a position separated from the user's finger or thumb.

In some embodiments, the first and second motors 15, 16 include the first motor 15 connected to the joint 11 via a reducer 33 with a reduction ratio ranging from 1 to 10.

In this configuration, the first motor 15 (first actuator) is connected to the joint 11 via the reducer 33 with a low reduction ratio, enabling the driving force of the first motor 15 (first actuator) to rotate the joint 11 with low inertia, which enables the arm 12 to rotate with good time responsiveness, thereby moving the slide block 13 with good time responsiveness.

In some embodiments, the joint 11 is a universal joint, wherein the universal joint is rotatably connected to the case 7 so as to be rotatable about the first rotational axis A1 extending the first direction which intersects with a longitudinal direction of the arm 12; and is rotatably connected to the arm 12 so as to be rotatable about the second rotational axis A2 extending in the second direction which intersects with the longitudinal direction of the arm 12 and the first direction.

In this configuration, the joint 11 is a universal joint. This feature allows the joint 11 to rotate about both the first rotational axis A1 and the second rotational axis A2, while also enabling the joint 11 to be made compact. Furthermore, the first rotational axis A1 and the second rotational axis A2 intersect with each other, which facilitates calculation of the rotational positions of the arm 12 (up-down rotational position θ and left-right rotational position φ).

In some embodiments, the first actuator includes the first motor 15 which has a first output shaft 31 extending coaxially with the first rotational axis A1 and fixed to the case 7, and rotates the arm 12 together with the connecting member 21 relative to the case 7, about the first rotational axis A1; and the second motor 16 which has a second output shaft 34 extending coaxially with the second rotational axis A2 and fixed to the arm 12, and rotates the arm 12 relative to the connecting member 21, about the second rotational axis A2.

In this configuration, using the first motor 15 and the second motor 16 facilitates a proper rotation of the arm 12.

In some cases, the present invention is embodied as a force feedback device 1 configured to present a force sense to the user's finger or thumb, in which the control device 3 further performs a force sense presentation operation to drive the first motor 15, the second motor 16, and the third motor 17, thereby moving the slide block 13 to a position where the slide block 13 is in close contact with the fingertip based on the position F of the fingertip relative to the case 7 calculated in the fingertip position calculation operation, and causing the first motor 15 and the second motor 16 to generate a rotational force such that a force is applied from the slide block 13 to the fingertip.

In this configuration, the force feedback device 1 can perform the force sense presentation operation to present force sense to the user's fingertip. When not presenting force sense to the fingertip, the force feedback device 1 can measure the position of the fingertip with the slide block 13 that is separated from the fingertip. When presenting force sense to the fingertip, the force feedback device 1 can bring the slide block 13 into close contact with the fingertip and present force sense to the fingertip via the slide block 13. With this configuration, when not presenting force sense to the fingertip, the force feedback device does not restrict the user's finger movements, enabling proper presentation of force sense to the fingertip.

In some embodiments, the control device 3 is connected to a network NW to which the measurement data processing device 6 is connected, the measurement data processing device 6 being configured to acquire fingertip position information indicating the position of the fingertip relative to the case 7, and transmit force sense information representing a force sense to be presented to the fingertip based on the acquired fingertip position information, wherein the control device 3 further performs a fingertip position transmission operation to transmit to the measurement data processing device 6 via the network NW, the fingertip position information indicating the position F of the fingertip relative to the case 7 and calculated in the fingertip position calculation operation, and wherein, when receiving the force sense information from the measurement data processing device 6 via the network NW, the control device 3 performs the force sense presentation operation based on the received force sense information.

In this configuration, the measurement data processing device 6 connected to the network NW receives fingertip position information, uses the fingertip position information to calculate the position of the fingertip, and transmits the force sense information to the control device 3, enabling the control device 3 to present force sense to the fingertip, which facilitates the measurement of finger motions and the presentation of force sense to the fingertip by using the force feedback device 1.

In some embodiments, The force feedback device 1 includes the head-mounted display 49 for presenting an image, the display being connected to the control device, and wherein the measurement data processing device 6 transmits surrounding image information including image information related to surroundings of the user's hand, to the control device 3 via the network NW, and when receiving the surrounding image information, the control device 3 performs the image indication operation to display images of the surroundings of a user's hand corresponding to the surrounding image information, on the head-mounted display 49.

This configuration allows a user to easily recognize a state of the surroundings of the user's hand calculated by the measurement data processing device 6, allowing the user to move the fingers in a proper manner.

### GLOSSARY

1 force feedback device

3 control device

6 measurement data processing device

7 case (attachment unit)

11 joint

12 arm

13 slide block

14 distance sensor

15 first motor (first actuator)

16 second motor (first actuator)

17 third motor (second actuator)

21 connecting member

31 first output shaft

33 reducer

34 second output shaft

48 display

49 head-mounted display (display)

A1 first rotational axis

A2 second rotational axis

NW network

rS relative position

θ up-down rotational position

φ left-right rotational position

1. A measurement device configured to measure a position of a fingertip, the fingertip being the distal end of a finger or thumb of a user's hand, comprising:
an attachment unit to be attached to the user's hand;
an arm rotatably supported by the attachment unit via a joint;
a slide block supported on the arm so as to be movable in a longitudinal direction of the arm and including a distance sensor for measuring a distance therefrom to the fingertip;
a first actuator for driving the joint to rotate the arm;
a second actuator for moving the slide block; and
a control device for controlling the first actuator and the second actuator,
wherein the control device performs:
a sensor position calculation operation to calculate the position of the distance sensor;
a fingertip position calculation operation to calculate the position of the fingertip based on the position of the distance sensor calculated in the sensor position calculation operation and a result of measurement by the distance sensor;
and
a slide block movement operation to drive the first actuator and the second actuator to move the slide block to a position separated from the user's finger or thumb according to the position of the fingertip calculated in the fingertip position calculation operation.

2. The measurement device as claimed in claim 1, wherein the attachment unit is positioned on a side of a palm of the user's hand, and the arm is positioned on a side of a ball of the user's finger or thumb.

3. The measurement device as claimed in claim 1, wherein the first actuator includes a motor connected to the joint via a reducer with a reduction ratio ranging from 1 to 10.

4. The measurement device as claimed in claim 1, wherein the joint is a universal joint having a connecting member, wherein the connecting member is rotatably connected to the attachment unit to be rotatable about a first rotational axis extending in a first direction, the first direction intersecting with the longitudinal direction of the arm, and rotatably connected to the arm to be rotatable about a second rotational axis extending in a second direction, the second direction intersecting with both the longitudinal direction of the arm and the first direction.

5. The measurement device as claimed in claim 4, wherein the first actuator includes:
a first motor which has a first output shaft extending coaxially with the first rotational axis and fixed to the attachment unit, and rotates the arm together with the connecting member relative to the attachment unit, about the first rotational axis; and
a second motor which has a second output shaft extending coaxially with the second rotational axis and fixed to the arm, and rotates the arm relative to the connecting member, about the second rotational axis.

6. A force feedback device comprising the measurement device as claimed in claim 1, and configured to present a force sense to the user's finger or thumb,
wherein the control device further performs a force sense presentation operation to drive the first actuator and the second actuator, thereby moving the slide block to a position where the slide block is in close contact with the fingertip based on the position of the fingertip relative to the attachment unit calculated in the fingertip position calculation operation, and causing the first actuator to generate a rotational force such that a force is applied from the slide block to the fingertip.

7. The force feedback device as claimed in claim 6, wherein the control device is connected to a network to which a measurement data processing device is connected, the measurement data processing device being configured to acquire fingertip position information indicating the position of the fingertip relative to the attachment unit, and transmit force sense information representing a force sense to be presented to the fingertip based on the acquired fingertip position information,
wherein the control device further performs a fingertip position transmission operation to transmit to the measurement data processing device via the network, the fingertip position information indicating the position of the fingertip relative to the attachment unit and calculated in the fingertip position calculation operation, and
wherein, when receiving the force sense information from the measurement data processing device via the network, the control device performs the force sense presentation operation based on the received force sense information.

8. The force feedback device as claimed in claim 7, further comprising a display for presenting an image, the display being connected to the control device,
wherein the measurement data processing device transmits surrounding image information including image information related to surroundings of the user's hand, to the control device via the network, and
wherein, when acquiring the surrounding image information, the control device performs an image indication operation to display images corresponding to the surrounding image information on the display.
